(19) United States
(12) Patent Application Publication
(10) Pub. No.: US 2014/0317485 A1
(43) Pub. Date: Oct. 23, 2014

(54) APPARATUS FOR DISPLAYING HYPERLINKS USING KEYWORDS AND METHOD THEREOF

(71) Applicant: ELECTRONICS AND TELECOMMUNICATIONS RESEARCH INSTITUTE, Daejeon-city (KR)

(72) Inventors: Hadipurnawan SATRIA, Daejeon (KR); Kyung-Hee LEE, Daejeon (KR); Chae-Deok LIM, Daejeon (KR)

(73) Assignee: ELECTRONICS AND TELECOMMUNICATIONS RESEARCH INSTITUTE, Daejeon-city (KR)

(21) Appl. No.: 14/258,313

(22) Filed: Apr. 22, 2014

(30) Foreign Application Priority Data
Apr. 22, 2013 (KR) 10-2013-0044183

(51) Int. Cl. G06F 17/22

(52) U.S. Cl. CPC G06F 17/2235
USPC 715/206

(57) ABSTRACT

An apparatus for displaying hyperlinks using keywords and a method thereof are disclosed. The apparatus for display the hyperlinks using the keywords includes: a hyperlink list generating unit configured to collect hyperlinks included in a web document, select a target hyperlink among the hyperlinks, and generate a hyperlink list including the selected target hyperlink; a keyword list generating unit configured to select keywords corresponding the respective hyperlinks included in the hyperlink list and generate a keyword list including the keywords; and a control widget displaying unit configured to display the keywords following the hyperlink according to an input of a user in a control widget.

### CROSS REFERENCE TO RELATED APPLICATION

This application claims the benefit of Korean Patent Application No. 10-2013-0044183, filed on Apr. 22, 2013, which is hereby incorporated by reference in its entirety into this application.

### BACKGROUND OF THE INVENTION

1. Technical Field

The present invention relates to an apparatus for displaying hyperlinks using keywords and a method thereof, and more particularly, to an apparatus for displaying hyperlinks using keywords and a method thereof capable of selecting the keywords in hyperlinked text and displaying the selected keywords in a control widget which is separate from a web document.

2. Description of the Related Art

As portable devices including a touch panel become recently popular, a web surfing manipulation using the touch panel has been widely used.

In general, a user directly touches a hyperlink displayed in a webpage to drive the hyperlink. As such, when the user directly touches the hyperlink, the user may incorrectly enter another hyperlink due to a narrow interval between the hyperlinks.

In order to provide an intuitive interface to the manipulation of the touch panel, it is a very important factor to operate a desired function by a single input.

U.S. Patent Application Publication No. 2009-0128505, which relates to link target accuracy in touch-screen mobile devices by a layout adjustment, discloses a technology capable of preventing the incorrect input of another hyperlink by widening the interval between the hyperlinks to display the hyperlink when the user taps the hyperlinks.

In addition, U.S. Patent Application Publication No. 2011-0197116, which relates to a method and an apparatus for selecting hyperlinks, discloses a technology capable of preventing the incorrect input of another hyperlink by expanding a screen and changing a shape of the hyperlink to display the hyperlink when the user taps the hyperlinks.

However, the technologies of displaying the hyperlink according to the conventional art disclose only the technologies of widening the interval, changing the shape, or expanding the screen to prevent the incorrect input of the hyperlink, and still have the problem that the user should directly touch the desired hyperlinks.

Therefore, a technology of displaying a new hyperlink capable of providing the keywords in hyperlinked text to the screen by a separate control widget to allow the user not to directly touch the desired hyperlink and to touch only the keywords in the control widget to follow the hyperlink has been urgently demanded.

### SUMMARY OF THE INVENTION

Accordingly, the present invention has been made keeping in mind the above problems occurring in the conventional art, and an object of the present invention is to display hyperlinks capable of preventing an incorrect input which is generated when a user directly touches and inputs the hyperlink by providing keywords in hyperlinked text to a screen by a separate control widget.

Another object of the present invention is to display hyperlinks capable of preventing an incorrect input which is generated when a user touches a control widget and inputs keywords by displaying the keywords as much as a preset number in a control widget.

Yet another object of the present invention is to display hyperlinks capable of distinguishing the hyperlinks by only keywords in a control widget by selecting the keyword based on the leftmost word of the hyperlinked text and selecting the keyword by using a next right word or adding different suffixes when the keywords are overlapped because they are equal.

Yet another object of the present invention is to display hyperlink having more efficiency by excluding hyperlinks having low probability of following such as categories in a web document from a display target.

In accordance with an aspect of the present invention, there is provided an apparatus for display hyperlinks using keywords, the apparatus including: a hyperlink list generating unit configured to collect hyperlinks included in a web document, select a target hyperlink among the hyperlinks, and generate a hyperlink list including the selected target hyperlink; a keyword list generating unit configured to select keywords corresponding the respective hyperlinks included in the hyperlink list and generate a keyword list including the keywords; and a control widget displaying unit configured to display the keywords following the hyperlink according to an input of a user in a control widget.

The control widget displaying unit may display the keywords in the control widget as much as a preset number and set other keywords to a hidden state which is any one of a left hidden state and a right hidden state.

When a swipe input is present in the control widget, the control widget displaying unit may differently display the keywords of hidden state in the control widget depending on a direction of the swipe input.

When the target hyperlink gets out of the screen according to a screen scroll input, the control widget displaying unit may set the keyword corresponding to the target hyperlink to the hidden state.

The control widget display unit may sequentially display the keywords corresponding to the target hyperlink from the left in the control widget in order in which the target hyperlink corresponding to the keyword is located at high place on the screen.

The keyword list generating unit may select the leftmost word of the target hyperlinked text as the keyword.

The keyword list generating unit may determine whether the same word is present in the selected keywords and re-select a right word of the leftmost word of the target hyperlinked text as the keyword when the same word is present.

The keyword list generating unit may determine whether the same word is present in the selected keywords and add different suffixes to the word to re-select the word as the keyword when the same word is present.

The hyperlink list generating unit may determine whether the hyperlinks have any arrangement of a vertical arrangement and a horizontal arrangement, select the hyperlinks as the target hyperlink when the hyperlinks have the vertical arrangement, and may not select the hyperlinks as the target hyperlink when the hyperlinks have the horizontal arrangement.

The hyperlink list generating unit may determine whether or not the hyperlinks are a followed hyperlink and may not select the hyperlinks as the target hyperlink when the hyperlinks are the followed hyperlink.

In accordance with another aspect of the present invention, there is provided a method for displaying hyperlinks using keywords, the method including: collecting hyperlinks included in a web document, selecting a target hyperlink among the hyperlinks, and generating a hyperlink list including the selected target hyperlink; selecting keywords corresponding the respective hyperlinks included in the hyperlink list and generating a keyword list including the keywords; and displaying the keywords following the hyperlink according to an input of a user in a control widget.

In the displaying of the control widget on a screen, the keywords may be displayed in the control widget as much as a preset number and other keywords may be set to a hidden state which is any one of a left hidden state and a right hidden state. In the displaying of the control widget on a screen, when a swipe input is present in the control widget, the keywords of hidden state may be differently displayed in the control widget depending on a direction of the swipe input.

In the displaying of the control widget on a screen, when the target hyperlink gets out of the screen according to a screen scroll input, the keyword corresponding to the target hyperlink may be set to the hidden state.

In the displaying of the control widget on a screen, the keywords corresponding to the target hyperlink may be sequentially displayed from the left in the control widget in order in which the target hyperlink corresponding to the keyword is located at high place on the screen.

In the generating of the keyword list, the leftmost word of the target hyperlinked text may be selected as the keyword.

In the generating of the keyword list, whether the same word is present in the selected keywords may be determined and a right word of the leftmost word of the target hyperlinked text may be re-selected as the keyword when the same word is present.

In the generating of the keyword list, whether the same word is present in the selected keywords may be determined and different suffixes may be added to the word to re-select the word as the keyword when the same word is present.

In the generating of the hyperlink list, whether the hyperlinks have any arrangement of a vertical arrangement and a horizontal arrangement may be determined, when the hyperlinks have the vertical arrangement, the hyperlinks may be selected as the target hyperlink, and when the hyperlinks have the horizontal arrangement, the hyperlinks may not be selected as the target hyperlink.

In the generating of the hyperlink list, whether or not the hyperlinks are a followed hyperlink may be determined and when the hyperlinks are the followed hyperlink, the hyperlinks may not be selected as the target hyperlink.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for displaying hyperlinks using keywords according to an embodiment of the present invention;

FIG. 2 is an operation flow chart illustrating a method for displaying hyperlinks using keywords according to an embodiment of the present invention;

FIG. 3 is a diagram illustrating an example of a display of a control widget 370 according to an embodiment of the present invention;

FIG. 4 is a diagram illustrating an example of a swipe input 410 according to an embodiment of the present invention;

FIG. 5 is a diagram illustrating an example of a result of the swipe input 410 shown in FIG. 4;

FIG. 6 is a diagram illustrating an example of a screen scroll input 610 according to an embodiment of the present invention;

FIG. 7 is a diagram illustrating an example of a result of the screen scroll input 610 shown in FIG. 6; and

FIG. 8 is a diagram illustrating an example of selecting a keyword list according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the accompanying drawings.

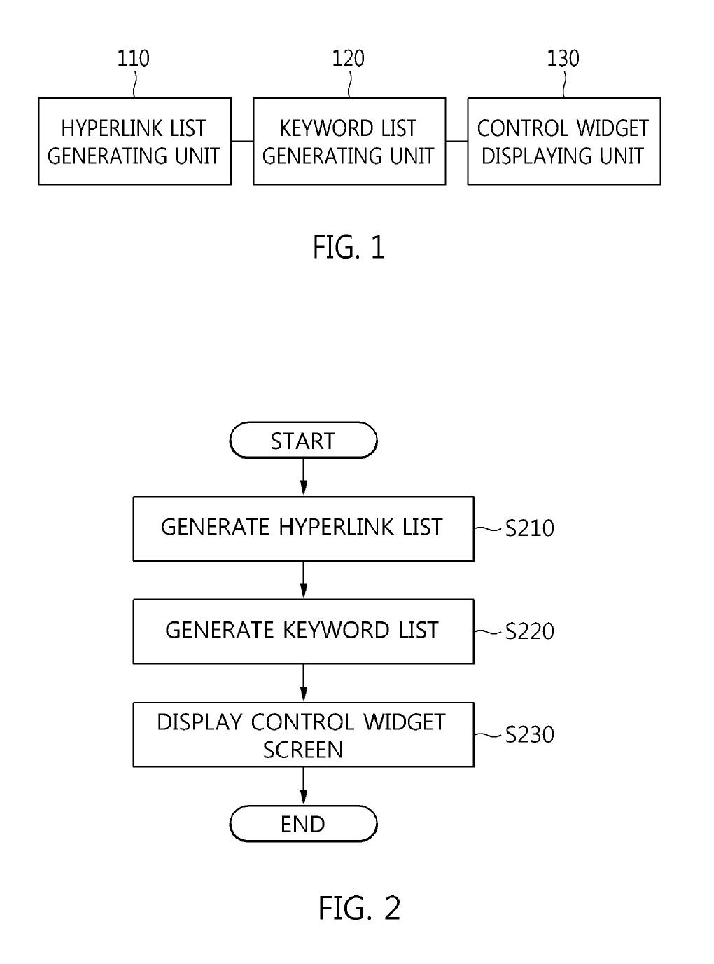

FIG. 1 is a block diagram illustrating an apparatus for displaying hyperlinks using keywords according to an embodiment of the present invention.

Referring to FIG. 1, the apparatus for displaying the hyperlinks using the keywords includes a hyperlink list generating unit 110, a keyword list generating unit 120, a control widget displaying unit 130.

The hyperlink list generating unit 110 collects hyperlinks included in a web document, selects a target hyperlink among the hyperlinks, and generates a hyperlink list including the selected target hyperlink.

In this case, the hyperlink list generating unit 110 may determine whether the hyperlinks have any arrangement of a vertical arrangement and a horizontal arrangement, may select the hyperlinks as the target hyperlink when the hyperlinks have the vertical arrangement, and may not select the hyperlinks as the target hyperlink when the hyperlinks have the horizontal arrangement.

In this case, the hyperlink list generating unit 110 may determine whether or not the hyperlinks are a followed hyperlink and may not select the hyperlinks as the target hyperlink when the hyperlinks are the followed hyperlink.

The keyword list generating unit 120 selects keywords corresponding to the respective hyperlinks included in the hyperlink list and generates a keyword list including the keywords.

In this case, the keyword list generating unit 120 may select the leftmost word of the target hyperlinked text as the keyword.

In this case, the keyword list generating unit 120 may determine whether the same word is present in the selected keywords and may re-select a right word of the leftmost word of the target hyperlinked text as the keyword when the same word is present.

In this case, the keyword list generating unit 120 may determine whether the same word is present in the selected keywords and may add different suffixes to the word to re-select the word as the keyword when the same word is present.

The control widget displaying unit 130 includes the keywords and displays a control widget 370 following the hyperlink corresponding to the keyword on a screen when the keyword is input.

In this case, the control widget displaying unit 130 may display the keywords in the control widget 370 as much as a preset number and may set other keywords to a hidden state which is any one of a left hidden state and a right hidden state.

In this case, when a swipe input is present in the control widget 370, the control widget displaying unit 130 may differently display the keywords of hidden state in the control widget 370 depending on a direction of the swipe input 410.

In this case, when the target hyperlink gets out of the screen according to a screen scroll input 610, the control widget displaying unit 130 may set the keyword corresponding to the target hyperlink to the hidden state.

In this case, as the target hyperlink corresponding to the keyword is located at high place on the screen, the control widget displaying unit 130 may display the keyword on the left in the control widget 370.

FIG. 2 is an operation flow chart illustrating a method for displaying hyperlinks using keywords according to an embodiment of the present invention.

Referring to FIG. 2, the method for displaying the hyperlinks using the keywords according to an embodiment of the present invention collects hyperlinks included in a web document, selects a target hyperlink among the hyperlinks, and generates a hyperlink list including the selected target hyperlink (S210).

In this case, in S210, whether the hyperlinks have any arrangement of a vertical arrangement and a horizontal arrangement may be determined, when the hyperlinks have the vertical arrangement, the hyperlinks may be selected as the target hyperlink, and when the hyperlinks have the horizontal arrangement, the hyperlinks may not be selected as the target hyperlink.

In this case, in S210, whether or not the hyperlinks are a followed hyperlink may be determined and when the hyperlinks are the followed hyperlink, the hyperlinks may not be selected as the target hyperlink.

Further, the method for displaying the hyperlinks using the keywords according to an embodiment of the present invention selects keywords corresponding to the respective hyperlinks included in the hyperlink list and generates a keyword list including the keywords (S220).

In this case, in S220, the leftmost word of the target hyperlinked text may be selected as the keyword.

In this case, in S220, whether the same word is present in the selected keywords may be determined and when the same word is present, a right word of the leftmost word of the target hyperlinked text may be re-selected as the keyword.

In this case, in S220, whether the same word is present in the selected keywords may be determined and when the same word is present, different suffixes may be added to the word to re-select the word as the keyword.

Further, the method for displaying the hyperlinks using the keywords according to an embodiment of the present invention includes the keywords and displays a control widget 370 following the hyperlink corresponding to a keyword on a screen when the keyword is input (S230).

In this case, in S230, the keywords may be displayed in the control widget 370 as much as a preset number and other keywords may be set to a hidden state which is any one of a left hidden state and a right hidden state.

In this case, in S230, when a swipe input is present in the control widget 370, the keywords of hidden state may be differently displayed in the control widget 370 depending on a direction of the swipe input 410.

In this case, in S230, when the target hyperlink gets out of the screen according to a screen scroll input 610, the keywords corresponding to the target hyperlink may be set to the hidden state.

In this case, in S230, as the target hyperlink corresponding to the keyword is located at high place on the screen, the keyword may be displayed on the left in the control widget 370.

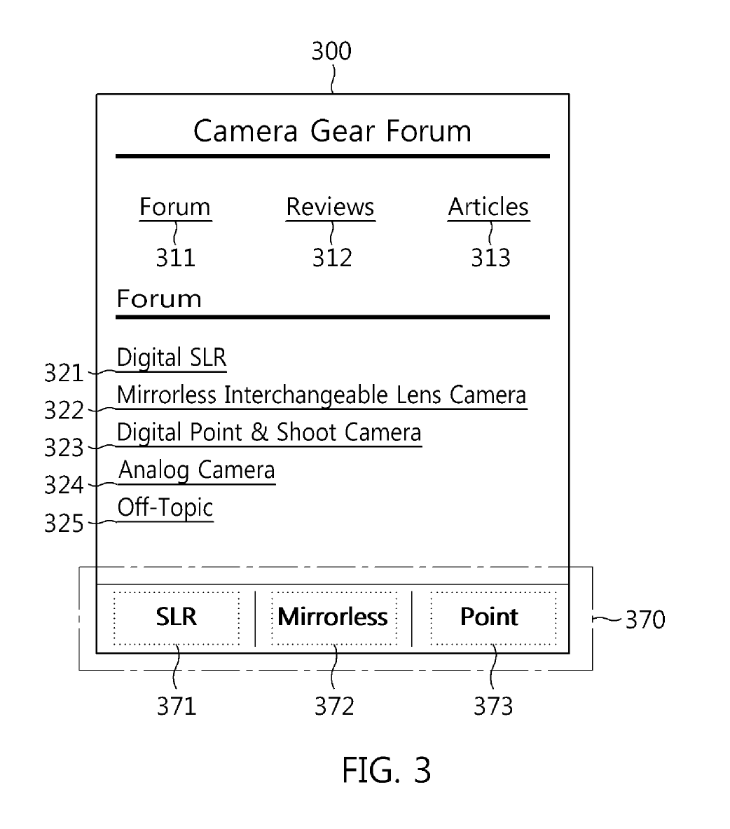

FIG. 3 is a diagram illustrating an example of a display of a control widget 370 according to an embodiment of the present invention.

Referring to FIG. 3, the control widget 370 according to an embodiment of the present invention is displayed on a screen of a touch panel 300.

The touch panel 300 may include any one of a liquid crystal display (LCD), a plasma display panel (PDD), an organic light emitting diode (OLED) display.

It may be appreciated that the hyperlinks included in the web document are displayed on the screen of the touch panel 300.

In this case, the hyperlinks may include a combination of words which may be input and an underline as hyperlinked text.

In this case, the hyperlinks may correspond to a horizontal arrangement and a vertical arrangement.

In this case, the hyperlinks may be a diagonal arrangement.

In this case, the hyperlink list generating unit 110 may collect the hyperlinks, select a target hyperlink among the hyperlinks, and generate a hyperlink list including the selected target hyperlink.

In this case, the hyperlink list generating unit 110 may determine whether the hyperlinks have any arrangement of the vertical arrangement and the horizontal arrangement, may select the hyperlinks as the target hyperlink when the hyperlinks have the vertical arrangement, and may not select the hyperlinks as the target hyperlink when the hyperlinks have the horizontal arrangement.

For example, the hyperlink list generating unit 110 may select vertical arrangement hyperlinks 321 to 325 among the hyperlinks as the target hyperlink.

For example, the hyperlink list generating unit 110 may not select horizontal arrangement hyperlinks 311 to 313 among the hyperlinks as the target hyperlink.

In this case, the keyword list generating unit 120 may selects keywords corresponding the respective hyperlinks included in the hyperlink list and generate a keyword list including the keywords.

In this case, the keyword list generating unit 120 may select the leftmost word of the target hyperlinked text as the keyword.

For example, the keyword list generating unit 120 may select “Digital” which is the leftmost word of a first vertical arrangement hyperlinked text 321 among the target hyperlink as a first keyword 371, may select “Mirrorless” which is the leftmost word of a second vertical arrangement hyperlinked text 322 as a second keyword 372, may select “Digital” which is the leftmost word of a third vertical arrangement hyperlinked text 323 as a third keyword 373, may select “Analog” which is the leftmost word of a fourth vertical arrangement hyperlinked text 324 as a fourth keyword 374, and may select “Off-Topic” which is the leftmost word of a fifth vertical arrangement hyperlinked text 325 as a fifth keyword 375.

In this case, the keyword list generating unit 120 may determine whether the same word is present in the selected keywords and may re-select a right word of the leftmost word of the target hyperlinked text as the keyword when the same word is present.

For example, when the first key word 371 and the third keyword 373 have the same word as “Digital”, the keyword list generating unit 120 may re-select “SLR” which is a right word of the leftmost word of the target hyperlinked text of the first vertical arrangement hyperlinked text 321 as the first keyword 371 and may re-select “Point” which is a right word of the leftmost word of the target hyperlinked text of the third vertical arrangement hyperlinked text 323 as the third keyword 373.

As such, the keyword list generating unit 120 may determine whether the same word is present in the selected keywords and may re-select the right word of the leftmost word of the target hyperlinked text as the keyword when the same word is present, thereby allowing the user to distinguish the keywords.

In this case, the control widget displaying unit 130 may include the keywords and display a control widget 370 following the hyperlink corresponding to a keyword on a screen when the keyword is input.

In this case, the control widget displaying unit 130 may display the keywords in the control widget 370 as much as a preset number and may set other keywords to a hidden state which is any one of a left hidden state and a right hidden state.

For example, when the preset number is three, the control widget displaying unit 130 may display “SLR” which is the first keyword 371, “Mirrorless” which is the second keyword 372, and “Point” which is the third keyword 373 in the control widget 370.

For example, when the preset number is three, the control widget displaying unit 130 may set “Analog” which is the fourth keyword 374 and “Off-Topic” which is the fifth keyword 375 to a right hidden state.

For example, when the preset number is four, the control widget displaying unit 130 may display “SLR” which is the first keyword 371, “Mirrorless” which is the second keyword 372, “Point” which is the third keyword 373, and “Analog” which is the fourth keyword 374 in the control widget 370.

For example, when the preset number is four, the control widget displaying unit 130 may set “Off-Topic” which is the fifth keyword 375 to a right hidden state.

In this case, the preset number may be set so that an interval between the keywords is not less than 1 cm to allow the user to easily click the keywords in the control widget 370.

In this case, when a swipe input 410 is present in the control widget 370, the control widget displaying unit 130 may differently display the keywords of hidden state in the control widget 370 depending on a direction of the swipe input 410.

For example, when the swipe input 410 is present from the right to the left in the control widget 370, the control widget displaying unit 130 may display the keywords which are set to the right hidden state in the control widget 370.

For example, when the swipe input 410 is present from the right to the left in the control widget 370, the control widget displaying unit 130 may display the fourth keyword 374 and the fifth keywords which are set to the right hidden state in the control widget 370.

In this case, the control widget displaying unit 130 may display the keywords 371 to 375 in the control widget so that the keywords 371 to 375 move in parallel with a direction of the swipe input 410.

In this case, the control widget displaying unit 130 may release the keywords which are input into the screen along the movement from the hidden state and set the keywords which get out of the screen along the movement to the hidden state while displaying the keywords 371 to 375 in the control widget so that the keywords 371 to 375 move in parallel with the direction of the swipe input 410.

For example, when the swipe input 410 is present from the right to the left in the control widget 370, the control widget displaying unit 130 may release the fourth keyword 374 and the fifth keyword 375 which are input into the screen from the right along the movement from the right hidden state and set the first keyword 371 and the second keyword 372 which get out of the screen to the left along the movement to the left hidden state while displaying the keywords 371 to 375 in the control widget so that the keywords 371 to 375 move to the left.

In this case, when the target hyperlink gets out of the screen according to a screen scroll input 610, the control widget displaying unit 130 may set the keywords corresponding to the target hyperlink to the hidden state.

In this case, the control widget display unit 130 may sequentially display the keywords corresponding to the target hyperlink from the left in the control widget 370 in order in which the target hyperlink corresponding to the keyword is located at high place on the screen.

For example, since the first vertical arrangement hyperlink 321, the second vertical arrangement hyperlink 322, the third vertical arrangement hyperlink 323, the fourth vertical arrangement hyperlink 324, and the fifth vertical arrangement hyperlink 325 among the target hyperlinks are sequentially located at the high place on the screen, the control widget displaying unit 130 may sequentially display “SLR” which is the first keyword 371 corresponding to the first vertical arrangement hyperlink 321, “Mirrorless” which is the second keyword 372 corresponding to the second vertical arrangement hyperlink 322, and “Point” which is the third keyword 373 corresponding to the third vertical arrangement hyperlink 323, from the left in the control widget 370.

Although not shown in FIG. 3, the hyperlink list generating unit 110 may determine whether or not the hyperlinks are a followed hyperlink and may not select the hyperlinks as the target hyperlink when the hyperlinks are the followed hyperlink.

Further, the keyword list generating unit 120 may determine whether the same word is present in the selected keywords and may add different suffixes to the word to re-select the word as the keyword.

For example, when the first keyword 371 and the third keyword 373 have the same word as “Digital”, the keyword list generating unit 120 may re-select “Digital*” that “*” is added to “Digital” as the third keyword 373.

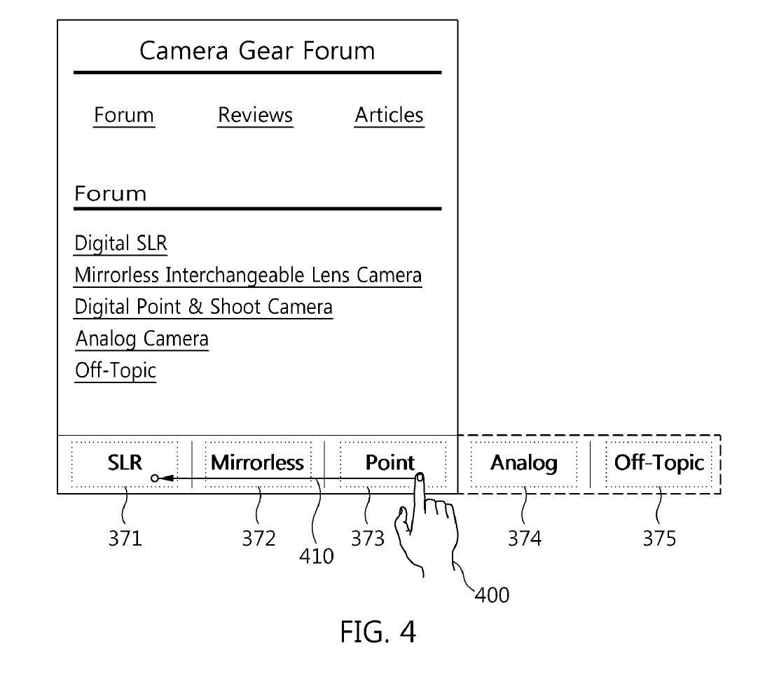

FIG. 4 is a diagram illustrating an example of a swipe input 410 according to an embodiment of the present invention.

An input unit 400 may include any one or more of a finger of a user and a stylus pen.

In this case, when a swipe input is present in the control widget 370, the control widget displaying unit 130 may differently display the keywords of hidden state in the control widget 370 depending on a direction of the swipe input 410.

For example, when the swipe input is present from the right to the left in the control widget 370, the control widget displaying unit 130 may display the keywords which are set to the right hidden state in the control widget 370.

For example, when the swipe input 410 is present from the right to the left in the control widget 370, the control widget displaying unit 130 may display the fourth keyword 374 and the fifth keywords which are set to the right hidden state in the control widget 370.

In this case, the control widget displaying unit 130 may display the keywords 371 to 375 in the control widget so that the keywords 371 to 375 move in parallel with a direction of the swipe input 410.

In this case, the control widget displaying unit 130 may release the keywords which are input into the screen along the movement from the hidden state and set the keywords which get out of the screen along the movement to the hidden state while displaying the keywords 371 to 375 in the control widget so that the keywords 371 to 375 move in parallel with the direction of the swipe input 410.

For example, when the swipe input 410 is present from the right to the left in the control widget 370, the control widget displaying unit 130 may release the fourth keyword 374 and the fifth keyword 375 which are input into the screen from the right along the movement from the right hidden state and set the first keyword 371 and the second keyword 372 which get out of the screen to the left along the movement to the left hidden state while displaying the keywords 371 to 375 in the control widget so that the keywords 371 to 375 move to the left.

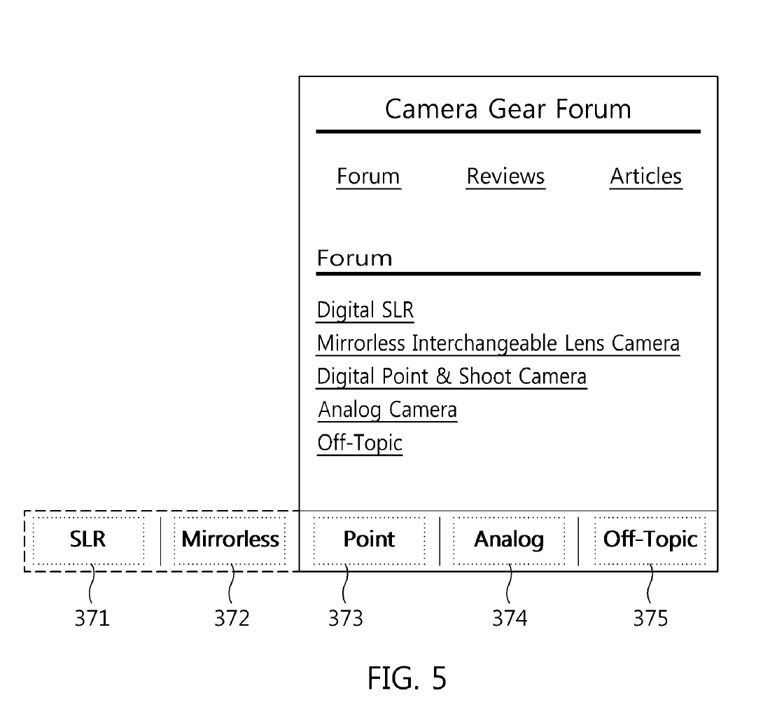

FIG. 5 is a diagram illustrating an example of a result of the swipe input 410 shown in FIG. 4.

Referring to FIG. 5, it may be appreciated from a result of the swipe input 410 shown in FIG. 4 that the keywords 371 to 375 in the control widget are moved to the left, such that the first keyword 371 and the second keyword 372 are set to the left hidden state, and the fourth keyword 374 and the fifth keyword 375 are released from the right hidden state.

Finally, it may be appreciated from a result of the swipe input 410 shown in FIG. 4 that the third keyword 373, the fourth keyword 374, and the fifth keyword 375 are displayed in the control widget 370.

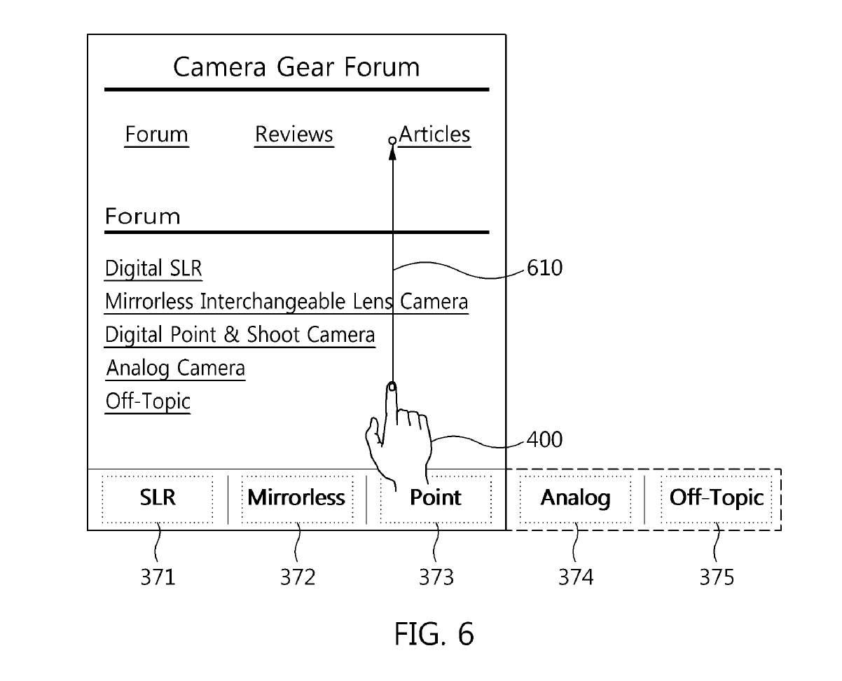

FIG. 6 is a diagram illustrating an example of a screen scroll input 610 according to an embodiment of the present invention.

An input unit 400 may include any one or more of a finger of a user and a stylus pen.

In this case, when the target hyperlink gets out of the screen according to a screen scroll input 610, the control widget displaying unit 130 may set the keywords corresponding to the target hyperlink to the hidden state.

For example, when the screen scroll input 610 is present from a bottom to a top, the control widget displaying unit 130 may set the keyword corresponding to the target hyperlink which gets out of the screen toward the top to the hidden state.

For example, when the screen scroll input 610 is present from a bottom to a top, the control widget displaying unit 130 may set the first keyword 371 corresponding to the first vertical arrangement hyperlink 321 which gets out of the screen toward the top to the left hidden state.

In this case, as the target hyperlink corresponding to the keyword is located at high place on the screen, the control widget displaying unit 130 may display the keyword on the left in the control widget 370.

For example, since the second vertical arrangement hyperlink 322, the third vertical arrangement hyperlink 323, the fourth vertical arrangement hyperlink 324, and the fifth vertical arrangement hyperlink 325 among the target hyperlinks are sequentially located at the high place on the screen, the control widget displaying unit 130 may sequentially display “Mirrorless” which is the second keyword 372 corresponding to the second vertical arrangement hyperlink 322, “Point” which is the third keyword 373 corresponding to the third vertical arrangement hyperlink 323, and “Analog” which is the fourth keyword 374 corresponding to the fourth vertical arrangement hyperlink 324, from the left in the control widget 370.

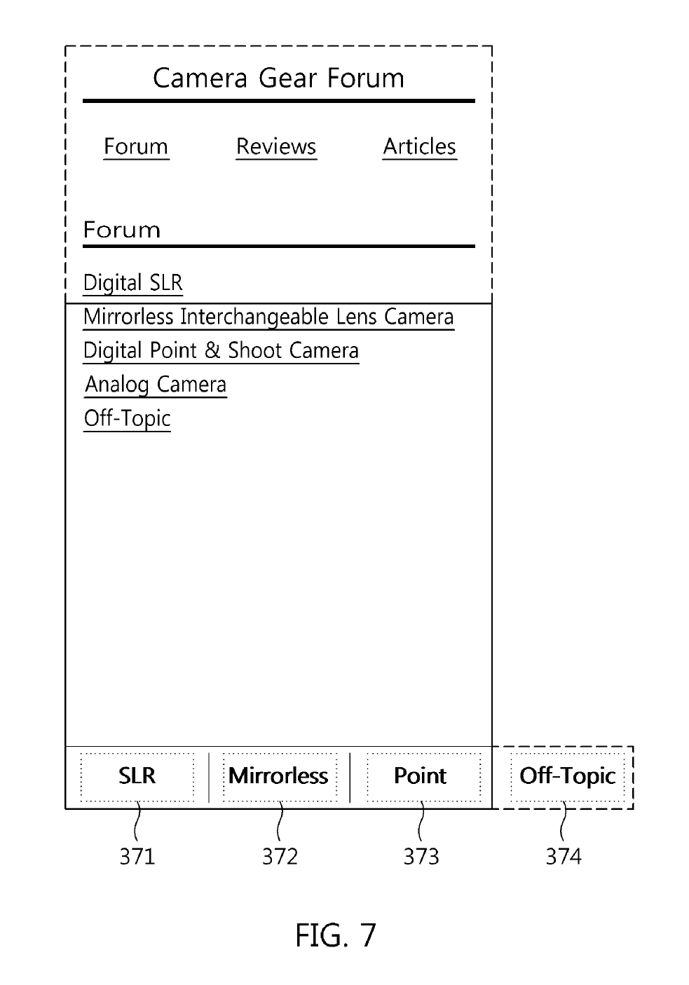

FIG. 7 is a diagram illustrating an example of a result of the screen scroll input 610 shown in FIG. 6.

Referring to FIG. 7, it may be appreciated from a result of the screen scroll input 610 shown in FIG. 6 that the first vertical arrangement hyperlink 321 gets out of the screen toward the top, and the first keyword 371 is set to the left hidden state, and the fourth keyword 374 is released from the right hidden state.

Finally, it may be appreciated from a result of the screen scroll input 610 shown in FIG. 6 that the second keyword 372, the third keyword 373, and the fourth keyword 374 are displayed in the control widget 370.

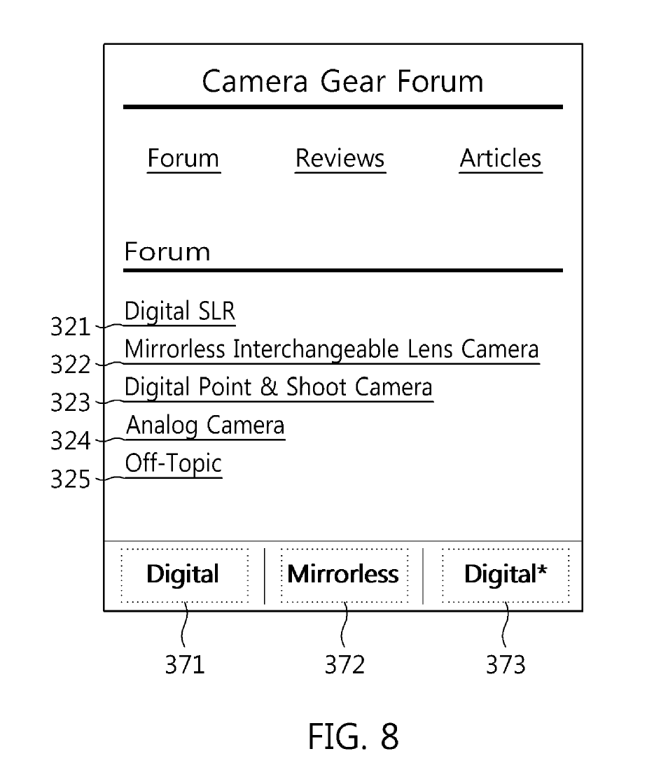

FIG. 8 is a diagram illustrating an example of selecting a keyword list according to an embodiment of the present invention.

Referring to FIG. 8, the keyword list generating unit 120 may select the leftmost word of the target hyperlinked text as the keyword.

For example, the keyword list generating unit 120 may select “Digital” which is the leftmost word of a first vertical arrangement hyperlinked text 321 among the target hyperlink as a first keyword 371, may select “Mirrorless” which is the leftmost word of a second vertical arrangement hyperlinked text 322 as a second keyword 372, may select “Digital” which is the leftmost word of a third vertical arrangement hyperlinked text 323 as a third keyword 373, may select “Analog” which is the leftmost word of a fourth vertical arrangement hyperlinked text 324 as a fourth keyword 374, and may select “Off-Topic” which is the leftmost word of a fifth vertical arrangement hyperlinked text 325 as a fifth keyword 375.

In this case, the keyword list generating unit 120 may determine whether the same word is present in the selected keywords and may add different suffixes to the word to re-select the word as the keyword.

For example, when the first keyword 371 and the third keyword 373 have the same word as “Digital”, the keyword list generating unit 120 may re-select “Digital*” that “*” is added to “Digital” as the third keyword 373.

As such, the keyword list generating unit 120 may determine whether the same word is present in the selected keywords and may add different suffixes to the word to re-select the word as the keyword when the same word is present, thereby allowing the user to distinguish the keywords.

In accordance with the present invention, the hyperlinks capable of preventing the incorrect input which is generated when the user directly touches and inputs the hyperlink can be displayed by providing the keywords in hyperlinked text to the screen by the separate control widget.

Further, in accordance with the present invention, the hyperlinks capable of preventing the incorrect input which is generated when the user touches the control widget and inputs the keywords can be displayed by displaying the keywords as much as the preset number in the control widget.

Further, in accordance with the present invention, the hyperlinks capable of distinguishing the hyperlinks by only keywords in the control widget can be displayed by selecting the keyword based on the leftmost word of the hyperlinked text and selecting the keyword by using the next right word or adding different suffixes when the keywords are overlapped because they are equal.

Further, in accordance with the present invention, the hyperlink having more efficiency can be displayed by excluding the hyperlinks having low probability of following such as the categories in the web document from the display target.

In the apparatus for displaying the hyperlinks using the keywords and the method thereof according to the preferred embodiment of the present invention as described above, the configuration and the method of the above-mentioned preferred embodiments are not restrictively applied. That is, all or some of the respective preferred embodiments may be selectively combined with each other so that they may be variously modified.

What is claimed is:

1. An apparatus for display hyperlinks using keywords, the apparatus comprising:
a hyperlink list generating unit configured to collect hyperlinks included in a web document, select a target hyperlink among the hyperlinks, and generate a hyperlink list including the selected target hyperlink;
a keyword list generating unit configured to select keywords corresponding the respective hyperlinks included in the hyperlink list and generate a keyword list including the keywords; and
a control widget displaying unit configured to display the keywords following the hyperlink according to an input of a user in a control widget.

2. The apparatus for displaying the hyperlinks using the keywords of claim 1, wherein the control widget displaying unit displays the keywords in the control widget as much as a preset number and sets other keywords to a hidden state which is any one of a left hidden state and a right hidden state.

3. The apparatus for displaying the hyperlinks using the keywords of claim 2, wherein when a swipe input is present in the control widget, the control widget displaying unit differently displays the keywords of hidden state in the control widget depending on a direction of the swipe input.

4. The apparatus for displaying the hyperlinks using the keywords of claim 3, wherein when the target hyperlink gets out of the screen according to a screen scroll input, the control widget displaying unit sets the keyword corresponding to the target hyperlink to the hidden state.

5. The apparatus for displaying the hyperlinks using the keywords of claim 4, wherein the control widget display unit sequentially displays the keywords corresponding to the target hyperlink from the left in the control widget in order in which the target hyperlink corresponding to the keyword is located at high place on the screen.

6. The apparatus for displaying the hyperlinks using the keywords of claim 4, wherein the keyword list generating unit selects the leftmost word of the target hyperlinked text as the keyword.

7. The apparatus for displaying the hyperlinks using the keywords of claim 6, wherein the keyword list generating unit determines whether the same word is present in the selected keywords and re-selects a right word of the leftmost word of the target hyperlinked text as the keyword when the same word is present.

8. The apparatus for displaying the hyperlinks using the keywords of claim 6, wherein the keyword list generating unit determines whether the same word is present in the selected keywords and adds different suffixes to the word to re-select the word as the keyword when the same word is present.

9. The apparatus for displaying the hyperlinks using the keywords of claim 4, wherein the hyperlink list generating unit determines whether the hyperlinks have any arrangement of a vertical arrangement and a horizontal arrangement, selects the hyperlinks as the target hyperlink when the hyperlinks have the vertical arrangement, and does not select the hyperlinks as the target hyperlink when the hyperlinks have the horizontal arrangement.

10. The apparatus for displaying the hyperlinks using the keywords of claim 4, wherein the hyperlink list generating unit determines whether or not the hyperlinks are a followed hyperlink and does not select the hyperlinks as the target hyperlink when the hyperlinks are the followed hyperlink.

11. A method for displaying hyperlinks using keywords, the method comprising:
collecting hyperlinks included in a web document, selecting a target hyperlink among the hyperlinks, and generating a hyperlink list including the selected target hyperlink;
selecting keywords corresponding the respective hyperlinks included in the hyperlink list and generating a keyword list including the keywords; and
displaying the keywords following the hyperlink according to an input of a user in a control widget.

12. The method for displaying the hyperlinks using the keywords of claim 11, wherein in the displaying of the control widget on a screen, the keywords are displayed in the control widget as much as a preset number and other keywords are set to a hidden state which is any one of a left hidden state and a right hidden state.

13. The method for displaying the hyperlinks using the keywords of claim 12, wherein in the displaying of the control widget on a screen, when a swipe input is present in the control widget, the keywords of hidden state are differently displayed in the control widget depending on a direction of the swipe input.

14. The method for displaying the hyperlinks using the keywords of claim 13, wherein in the displaying of the control widget on a screen, when the target hyperlink gets out of the screen according to a screen scroll input, the keyword corresponding to the target hyperlink is set to the hidden state.

15. The method for displaying the hyperlinks using the keywords of claim 14, wherein in the displaying of the control widget on a screen, the keywords corresponding to the target hyperlink are sequentially displayed from the left in the control widget in order in which the target hyperlink corresponding to the keyword is located at high place on the screen.

16. The method for displaying the hyperlinks using the keywords of claim 14, wherein in the generating of the keyword list, the leftmost word of the target hyperlinked text is selected as the keyword.

17. The method for displaying the hyperlinks using the keywords of claim 16, wherein in the generating of the keyword list, whether the same word is present in the selected keywords is determined and a right word of the leftmost word of the target hyperlinked text is re-selected as the keyword when the same word is present.

18. The method for displaying the hyperlinks using the keywords of claim 16, wherein in the generating of the keyword list, whether the same word is present in the selected keywords is determined and different suffixes are added to the word to re-select the word as the keyword when the same word is present.

19. The method for displaying the hyperlinks using the keywords of claim 14, wherein in the generating of the hyperlink list, whether the hyperlinks have any arrangement of a vertical arrangement and a horizontal arrangement is determined, when the hyperlinks have the vertical arrangement, the hyperlinks is selected as the target hyperlink, and when the hyperlinks have the horizontal arrangement, the hyperlinks is not selected as the target hyperlink.

20. The method for displaying the hyperlinks using the keywords of claim 14, wherein in the generating of the hyperlink list, whether or not the hyperlinks are a followed hyperlink is determined and when the hyperlinks are the followed hyperlink, the hyperlinks is not selected as the target hyperlink.
